(19) United States
(12) Patent Application Publication
(10) Pub. No.: US 2025/0074812 A1
(43) Pub. Date: Mar. 6, 2025

(54) METHOD FOR MANUFACTURING GLASS FIBERS FROM UNPROCESSED MINERAL MATERIALS

(71) Applicants: SAINT-GOBAIN ISOVER, COURBEVOIE (FR); SAINT-GOBAIN ADFORS, COURBEVOIE (FR)

(72) Inventors: Simonpietro DI PIERRO, ORMOY-VILLERS (FR); Octavio CINTORA GONZALEZ, TAVERNY (FR); Jean-Patrick COCHARD, ANTONY (FR); Aurélie ORTIZ, VERSAILLES (FR)

(21) Appl. No.: 18/557,653

(22) PCT Filed: Apr. 28, 2022
(86) PCT No.: PCT/FR2022/050821

§ 371 Date: Oct. 27, 2023

(30) Foreign Application Priority Data
Apr. 28, 2021 (FR) 2104440

(51) Int. Cl. C03C 3/091; C03C 1/00; C03C 3/078; C03C 13/04; C03C 13/06

(52) U.S. Cl. CPC C03C 3/091; C03C 1/002; C03C 3/078; C03C 13/045; C03C 13/06

(57) ABSTRACT

A method for manufacturing glass includes the melting of a mixture of raw materials constituting a melting bath including a source of silicon, a source of sodium, a source of boron and at least one source of calcium selected from a mixed oxide of calcium and at least one element selected from Si, Mg, Al, in particular a calcium silicate and/or a calcium aluminium silicate, and/or at least one source of magnesium selected from a mixed oxide of magnesium and at least one element selected from Si, Ca, in particular a magnesium silicate and optionally a source of aluminium selected from a mixed oxide of aluminium and at least one element selected from the group consisting of Si, Ca, Na, K, wherein the sources of calcium and/or of magnesium and/or of aluminium are natural mineral materials, that is to say are obtained from a natural geological medium and are unprocessed.

The invention relates to the field of melting a mixture of raw materials, in particular for the manufacture of glass wool as used in particular in the field of thermal and/or acoustic insulation of buildings or others. According to another aspect, the invention also relates to the manufacture of C-glass used in particular in the field of textile fibers and composite materials.

The manufacture, in particular by the applicant company, of glass wool by melting and drawing of natural and abundant raw materials (sand or volcanic rock), is a method that has been known and mastered for a long time. The insulating products thus obtained are in the form of a “mat” of glass wool composed of a structure varying from flexible to rigid and trapping air in a stable and immobile manner in the entanglement of fibers.

Glass wool has excellent thermal and acoustic properties that have given it a major role in the insulation of dwellings and non-residential buildings (tertiary, commercial, industrial) for more than 80 years. Forms under which the glass wool is sold are varied: rolls, flexible or semi-rigid panels to be unrolled, rigid panels, shells, layers or flakes.

By virtue of its entangled structure generating a multitude of small cavities, glass wool is a porous material trapping air. The stationary air trapped in these pores gives glass wool a strong insulating power with minimal material.

The base for manufacturing glass wool or C-glass is a (naturally abundant) quarry sand to which fluxes such as sodium carbonate are added, and at least one alkaline earth (to make the glass hydrolysis-resistant) such as limestone (calcium carbonate) and dolomite (CaMg)CO₃)₂). According to certain embodiments, boron can also be introduced to give it better chemical and hydrolytic resistance (in particular for C-glass) or to improve the thermal properties thereof, in particular for the glass blade. The fiberizing is carried out under conditions such that it is integral (no residues such as unmelted particles). The fiberizing is carried out by centrifuging through pierced plates. The molten material passes through a die and then into the continuous fiberizing plates from which it emerges in the form of glass strands which are sprayed with polymer (the binder) to form a mat. After adding binders and other elements specific to each use, the wool mat is polymerized and calendered.

The demanded criteria of industrial and economic feasibility and quality have been joined in recent years by the biodegradability of the glass wool, namely the capacity of the glass wool to dissolve rapidly in a physiological medium, in order to prevent any potential pathogenic risk related to the possible accumulation of the finest fibers in the body by inhalation, a glass wool composition adapted accordingly was proposed in application EP 399320, to which reference will be made for further details on this technique.

In parallel, a method is also known for the manufacture of glass fibers, in particular C-glass fibers.

C-glass is a glass specially designed for its better chemical resistance to solvents and water. The raw materials are melted and the glass obtained passes through orifices called bushings. The bushings are generally made of Pt. The glass strands, after exiting the bushing, are cooled in air or steam to form a mat.

It can be used in the form of a fiber of about 5 microns thickness and from 10 to 4000 microns in length, or up to a few centimeters in length.

The good chemical resistance of borosilicate C-glass makes it ideal for use for various applications such as in vinyl ester paints, epoxy acrylic and acrylic coatings as a barrier against corrosive attacks of chemical products and moisture.

Usually, the C-glass is also obtained by melting a bath of raw material comprising silica, limestone, feldspar, borax, sodium carbonate and optionally dolomite, the basic components being judiciously chosen to provide a glass composition producing fibers combining flexibility and robustness to mechanical traction as well as acid or basic chemical agents.

The molten mixture (glass fiber for insulation or C-glass) is thus usually prepared by melting raw materials comprising silica, a source of sodium, most often sodium carbonate Na₂CO₃, at least one alkaline earth (magnesium and/or calcium) source in the form of limestone (calcium carbonate) and/or dolomite (CaMg (CO₃)₂).

During the melting of the initial mixture for the manufacture of glass wool or C-glass, the carbonates release carbon dioxide from which the bubbles help to stir the mass being melted. Furthermore, certain carbonates, such as dolomite, even before releasing their CO₂, divide into finer particles according to the phenomenon called decrepitation, which can be fairly violent and generate dust that will clog and even corrode the various ducts equipping the ovens (chimneys, regenerators, etc.). In a conventional method for manufacturing glass wool or C-glass, the emission of CO₂ due to the melting of the raw materials is generally of the order of 10 to 25% of the total mass of the raw materials used.

Moreover, the carbon dioxide is a greenhouse gas and it is desirable to develop methods for manufacturing mineral wool generating the least CO₂ possible for environmental reasons, while leading to a product of good quality for an acceptable cost.

In addition to the release of CO₂ directly during the method for melting the melt of raw materials, it is therefore important to consider the method for manufacturing glass in its entirety, taking into account other factors such as the transport of raw materials or even the energy cost of providing said raw materials for use in the method for manufacturing the glass. In such an aim, the use of unprocessed mineral raw materials, in place of synthetic materials removed of their impurities as currently used, has the advantage of contributing to the reduction of CO₂ emissions since no processing energy other than the melting step enters the overall balance of said manufacturing.

The choice of raw materials mentioned above is essential to obtain a good quality of the glass, in particular after its fiber drawing. Among the properties judged as essential, mention may in particular be made of the yield of the melt (ratio between the amount of glass produced and the amount of raw materials charged), the quality of the refining which is reflected by a minimal number of residual bubbles in the glass, the homogeneity of the glass (in particular the homogeneity of SiO₂), as well as the number of unmelted materials.

The energy consumption (energy necessary for the melting of the mixture of raw materials) is also a factor to be taken into account. In summary, with a goal of reducing the energy costs and optimizing the CO₂ balance, it is important to take into account all of the steps resulting in the formation of glass and to the preparation of the raw materials in addition to the final step of melting the bath of raw materials.

The object of the present invention is to contribute to solving such a technical problem by proposing a method for manufacturing glass fiber for which CO₂ emissions are effectively reduced, on the basis of all the steps resulting in the formation of said glass fiber and for which the steps of material transformation before the melting of the bath were simplified, for at least equivalent quality of the glass ultimately obtained.

This mixture of raw materials is intended to be heated to a particular temperature under conditions that together allow it to melt to obtain a molten bath satisfying said final target composition of the glass fiber.

The originality of the present invention lies in the choice of raw materials. Indeed, it has been discovered that it was possible to use natural mineral oxides, in particular natural silicates, that is in their initial geological composition after their extraction from their deposit, in particular without chemical impairment intended to modify the initial composition thereof, that is to say mineral materials not chemically processed, as a calcium and/or magnesium source, or even as an aluminum source, this choice leading to a reduction in the release of CO₂ during the melting reaction. In particular, according to the method of the present invention, it is initially based on the exact composition of these unprocessed geological mineral materials, as determined precisely by any suitable technique (for example chemical analysis, X-ray diffraction, etc.) to determine the composition of the initial melt. More precisely, on the basis of this initial determination of the composition of the mineral material, the necessary proportions are calculated and adjusted in the other components of said initial bath (such as silica, sodium carbonate or hydroxide, and potentially additional limestone and/or dolomite) to arrive at said target composition; thus, the amount of CO₂ released is minimized, as measured over all of the steps leading to the formation of the glass fibers, and not only based on the final melting of the bath of raw materials.

According to the invention, however, said mineral oxides may of course undergo steps prior to their use as raw material of the melt but without chemical processing of the crystalline grains constituting the mineral oxide. Such steps may be crushing, screening, washing or flotation, magnetic separation or any other physical separation of the impurities present between said grains of the natural mineral material.

More specifically, the present invention relates to a method for manufacturing glass, in particular glass fibers having a target composition, comprising the melting of a mixture of raw materials constituting a melting bath, said target composition meeting the following criteria, in weight percentages:
SiO₂: between 50 and 75%, preferably between 60 and 70%,
Na₂O: between 10 and 25%, preferably between 10 and 20%,
CaO: between 5 and 15%, preferably between 5 and 10%,
MgO: between 1 and 10%, preferably between 2 and 5%,
CaO and MgO together representing preferably between 5 and 20%,
B₂O₃: between 0 and 10%, preferably between 2 and 8%, preferably less than 6%,
Al₂O₃: between 0 and 8%, preferably between 1 and 6%,
K₂O: between 0 and 5%, preferably between 0.5 and 2%,
Na₂O and K₂O together representing preferably between 12 and 20%,
Iron oxide: between 0 and 3%, preferably less than 2%, more preferably less than 1%,
other oxide(s): between 0 and 5% in total by weight, preferably less than 3% in total,
the remainder consisting of unavoidable impurities,
said method being characterized in that it comprises the following steps:
a) selecting the raw materials of said melt from, at least:
   a silicon source, in particular chosen from silica, a glass cullet, recycled mineral fibers, in particular recycled glass wool, in particular a mixture of silica and glass cullet or a mixture of silica and recycled mineral fibers, or a mixture of silica, glass cullet and recycled mineral fibers,
   at least one sodium source preferably selected from sodium hydroxide NaOH, sodium carbonate Na₂CO₃ or a mixture of sodium hydroxide NaOH and sodium carbonate Na₂CO₃,
   at least one boron source preferably selected from a boron oxide such as pentaborax or a mixed oxide of boron with at least one element selected from the group consisting of Si, Mg, Ca, in particular an oxide selected from the group consisting of colemanite, ulexite, tincalconite or kernite,
   at least one calcium source selected from a mixed oxide of calcium with at least one element selected from the group consisting of Si, Mg, Al, in particular a calcium silicate and/or an aluminum and calcium silicate, and/or
   at least one magnesium source selected from a mixed oxide of magnesium with at least one element selected from the group consisting of Si, Ca, in particular a magnesium silicate,
   optionally at least one aluminum source selected from a mixed aluminum oxide with at least one element selected from the group consisting of Si, Ca, Na, K in particular an aluminum silicate, for example kaolin, nepheline, or pyrophyllite,
wherein said calcium and/or magnesium and/or aluminum sources are natural mineral materials, that is unprocessed mineral materials originating from a natural geological environment,
   optionally, limestone CaCO₃ or a calcium hydroxide such as Portlandite Ca(OH)₂,
   optionally dolomite CaMg(CO₃)₂,
   optionally, hydrated alumina (Al(OH)₃) or calcinated alumina Al₂O₃,
b) the composition of said sources of calcium and/or magnesium and/or natural aluminum is determined,
c) on the basis of said composition(s) determined according to point b), determining the necessary quantities of said raw materials to obtain a glass of said target composition,
d) mixing said materials according to said quantities,
e) the melting of said mixture and its cooling under conditions making it possible to obtain said glass, in particular in the form of fibers after fiber drawing.

According to particular and advantageous embodiments of the present invention, which may of course be combined with one another:
One calcium source is a natural mineral calcium silicate comprising, in percentage by weight, more than 30% of SiO₂ and more than 10% CaO, preferably more than 15% CaO, CaO and SiO₂ together representing more than 60%, or more than 70% or even more than 80% of the total weight of said source.
One magnesium source is a natural mineral magnesium silicate comprising, in percentage by weight, more than 30% of SiO₂ and more than 10% MgO, preferably more than 15% MgO, MgO and SiO₂ together representing more than 60%, or more than 70% or even more than 75% of the total weight of said source.
The raw materials of said molten bath comprise a calcium source as described above and a magnesium source as described above.
One magnesium source is a natural mineral material corresponding to the following composition, in percentages by weight:
SiO₂: between 40 and 55%, preferably between 45 and 50%,
Al₂O₃: between 0 and 10%, for example between 1 and 10%,
MgO: between 20 and 40%, preferably between 25 and 35%,
MgO and SiO₂ cumulatively representing preferably at least 70%, or even at least 75%,
Fe₂O₃: between 0 and 4%, for example between 1 and 3%
less than 5% of other oxides, preferably less than 3% of other oxides
optionally water, in particular present in said source in the form of hydroxide(s), preferably in an amount of less than 20% and in particular between 5 and 15%.
One magnesium source is a natural mineral material corresponding to the following composition, in percentages by weight:
SiO₂: between 55 and 70%, preferably between 58 and 65%,
Al₂O₃: between 0 and 10%, for example between 1 and 10%
MgO: between 20 and 40%, preferably between 25 and 35%,
MgO and SiO₂ cumulatively representing preferably at least 85%, or even at least 90%,
Fe₂O₃: between 0 and 4%, for example between 0.5 and 2%,
less than 5% of other oxides, preferably less than 3% of other oxides,
optionally water, preferably in an amount of less than 20% and in particular between 5 and 15%.
One magnesium source is a natural mineral material corresponding to the following composition, in percentages by weight:
SiO₂: between 30 and 50%, preferably between 35 and 45%,
Al₂O₃: between 0 and 10%, for example between 1 and 5%
MgO: between 25 and 45%, preferably between 30 and 40%,
MgO and SiO₂ cumulatively representing preferably at least 70%, or even at least 75%,
Fe₂O₃: between 0 and 10%, for example between 5 and 10% less than 5% of other oxides, preferably less than 3% of other oxides
optionally water, preferably in an amount of less than 20% and in particular between 5 and 15%.
One calcium source is a natural mineral material corresponding to the following composition, in percentages by weight:
SiO₂: between 30 and 55%, preferably between 35 and 52%,
CaO: between 35 and 55%, preferably between 40 and 50%,
CaO and SiO₂ cumulatively representing preferably at least 80%, or even at least 85%,
Fe₂O₃: between 0 and 4%, for example between 0.1 and 0.5%,
Al₂O₃: between 0 and 5%, for example between 0.5 and 2%
CO₂: between 0 and 20%, in particular between 5 and 15%
less than 5% of other oxides, preferably less than 3% of other oxides.
One calcium source is a natural mineral material corresponding to the following composition, in percentages by weight:
SiO₂: between 40 and 55%, preferably between 40 and 50%,
CaO: between 10 and 30%, preferably between 12 and 20%,
CaO and SiO₂ cumulatively representing preferably at least 55%, or even at least 60%,
Al₂O₃: between 10 and 40%, for example between 25 and 35%,
Fe₂O₃: between 0 and 4%, for example between 0.1 and 1%,
Na₂O: between 0 and 4%,
less than 5% of other oxides, preferably less than 3% of other oxides.
At least one magnesium source as described above and at least one calcium source as described above are used as raw materials.
All the silicates present in the molten bath represent more than 20% of the total weight of said bath, excluding silica and recycled cullet, preferably more than 30%, or even more than 40% or even more than 45% of the total weight of said bath, excluding silica and the recycled cullet.
Recycled glass cullet and/or recycled mineral fibers are introduced into the molten bath, in particular recycled glass wool fibers, recycled glass cullet and/or recycled mineral fibers preferably representing between 1 and 60% of the total weight of the molten bath, preferably between 1 and 50% of the total weight of the molten bath, more preferably between 20 and 40% of the total weight of the molten bath.
Said glass cullet corresponds to the following composition, in percentage by weight:
SiO₂: between 65 and 80%, preferably between 70 and 75%,
Na₂O: between 5 and 20%, preferably between 8 and 15%
CaO: between 5 and 20%, preferably between 8 and 15%
Al₂O₃: between 0 and 10%, preferably less than 5%
MgO: between 0 and 5%, preferably less than 3%,
Fe₂O₃: between 0 and 2%, preferably less than 1%,
less than 5% of other oxides, preferably less than 3% of other oxides.

The invention also relates to a mixture of raw materials described above.

The hydroxides (OH) are considered according to the present invention to be oxides and as part of the chemical composition of the source, unlike free water (that is present in the form of moisture in the natural mineral material).

It was thus possible to obtain glass fibers without defects from the initial mixture according to the invention, as will be shown in the following examples.

According to the invention, as little carbonate as possible, or even no carbonate, is introduced into the mixture of raw materials. Preferably, the sum of the weight of alkaline carbonate and alkaline earth carbonate is less than 35%, preferably less than 30%, and preferably less than 10%, and preferably less than 5%, and preferably less than 1% by weight, or even is zero in the mixture of raw materials. According to one advantageous possible embodiment, the mixture of raw materials is free of any carbonates. It is advantageously capable of releasing substantially no carbon oxide during its heating and melting into mineral wool.

One of the raw materials bearing silicon can be introduced into the mixture of raw materials in the form of sand as a main or secondary silicon source. Also, a main or secondary silicon source may consist of glass cullet.

A possible raw material carrying aluminum can be introduced into the mixture of raw materials in the form of bauxite Al₂O₃ or feldspar powder for example of general composition (K,Na)AlSi₃O₈, as a main or secondary source of aluminum.

The mixture of raw materials is heated until a molten bath is obtained, generally in a furnace. Heating is carried out more or less at temperature and more or less long depending on the quality of the mineral fibers that is sought, in particular depending on the degree of tolerance to unmelted particles. Generally, the heating temperature of the initial mixture is between 120° and 1500° C. for its complete melting. For the conversion of the mixture of raw materials, use may be made of melting techniques well known to a person skilled in the art. This processing can be carried out in any type of furnace like an electric arc furnace, an overhead burner furnace such as a cross-fired furnace or a continuous furnace, a submerged burner furnace.

The mixture of raw materials, in particular powder materials, may optionally be wetted before introduction into a furnace in order to reduce the fly-offs of raw materials in the furnace due to the combustion gas streams.

For heating and melting, the mixture of raw materials, wetted if appropriate, can be introduced into a furnace in a powdered state, which implies that each raw material that it contains is in the powder state or in the form of briquettes, the introduction potentially being done in one or more steps. For heating and melting, the mixture of raw materials, wetted if appropriate, can be introduced into a furnace in the form of a composition comprising cullet and the mixture of raw materials, the latter being in the powder state, if appropriate.

The examples which follow, given purely by way of illustration, show the advantages obtained by application of the present invention.

### EXAMPLES

According to a first series of examples, different mixtures of raw materials are prepared in order to compare a mixture as currently used for the manufacture of glass wool or C-glass to obtain a substantially identical glass composition, which substantially has the following formulation in percentage by weight:

TABLE 1

| Elements | Weight % |
|---|---|
| SiO₂ | 65.6 |
| CaO | 8.1 |
| B₂O₃ | 4.5 |
| Na₂O | 16.4 |
| MgO | 2.4 |
| Al₂O₃ | 2.1 |
| Fe₂O₃ | <1 (pref <0.5) |
| K₂O | 0.7 |
| Other oxides | impurities |

### Example 1 (Prior Art)

According to a first example, a typical glass composition corresponding to the preceding formulation is synthesized according to the current techniques.

Table 2 below gives the proportions of the various raw materials and the final composition of the mixture thus obtained:

TABLE 2

| | | Bath | SiO₂ | Al₂O₃ | Na₂O | K₂O | CaO | MgO | B₂O₃ | Fe₂O₃ | CO₂ | H₂O |
|---|---|---|---|---|---|---|---|---|---|---|---|---|
| Name | Formula | grams | Weight % | | | | | | | | | |
| Sand | SiO₂ | 572.90 | 99.60 | 0.05 | | 0.01 | 0.03 | | | 0.03 | | |
| Feldspar | (K,Na)AlSi₃O₈ | 120.80 | 70.60 | 17.05 | 5.65 | 5.20 | 0.10 | 0.01 | | 0.20 | | |
| Na-carbonate | Na₂CO₃ | 237.50 | | | 58.10 | | | | | | 41.89 | |
| Borax | Na₂B₄O₇•5H₂O | 92.60 | | | 21.5 | | | | 48.5 | | | 28.8 |
| Limestone | CaCO₃ | 83.90 | 0.05 | 0.02 | | | 55.55 | 0.25 | | 0.06 | 44.11 | |
| Dolomite | CaMg(CO₃)₂ | 111.40 | 0.05 | 0.05 | | | 30.60 | 21.30 | | 0.16 | 47.80 | |

| | | | | | | | | |
|---|---|---|---|---|---|---|---|---|
| Final glass composition (% weight) | 65.6 | 2.10 | 16.5 | 0.6 | 8.1 | 2.4 | 4.5 | 0.06 |

The mixture of raw materials is introduced hot into a platinum crucible in a flame furnace (air-gas or oxy-gas combustion) at 1450° C. until the mixture is completely melted for a total duration of 3 h15 including 120 min of refining. The amount of CO₂ released is 190 grams.

### Example 2

In this example, the mixture of raw materials is this time as described in Table 3 below.

Into this initial mixture, to replace the dolomite, another natural mineral material of a magnesium and silicon oxide, directly taken from a quarry called “Trimouns”, located in Luzenac, France, was introduced as reagent.

The hydroxides are considered according to the present invention as being part of the chemical composition of the source, unlike free water (that is present in the form of moisture in the natural mineral material). They are indicated in the table below in H₂O equivalent.

This material is directly introduced, without any chemical processing and after simple grinding aimed at adjusting the particle size thereof, in mixture with the other constituents in proportions adjusted accordingly to obtain a molten bath of oxides with a composition very close to that of the reference example 1.

TABLE 3

| | | Bath | SiO₂ | Al₂O₃ | Na₂O | K₂O | CaO | MgO | B₂O₃ | Fe₂O₃ | CO₂ | H₂O |
|---|---|---|---|---|---|---|---|---|---|---|---|---|
| Name | Formula | grams | Weight % | | | | | | | | | |
| Sand | SiO₂ | 526.50 | 99.60 | 0.05 | | 0.01 | 0.03 | | | 0.03 | | |
| Feldspar | (K,Na)AlSi₃O₈ | 120.80 | 70.60 | 17.05 | 5.65 | 5.20 | 0.10 | 0.01 | | 0.20 | | |
| Na-carbonate | Na₂CO₃ | 237.50 | | | 58.1 | | | | | | 41.9 | |
| Borax | Na₂B₄O₇•5H₂O | 92.60 | | | 21.5 | | | | 48.5 | | | 28.8 |
| Limestone | CaCO₃ | 145.30 | 0.05 | 0.02 | | | 55.55 | 0.25 | | 0.06 | 44.11 | |

| | | | | | | | |
|---|---|---|---|---|---|---|---|
| “Trimouns” | 75 | 61.7 | 0.2 | 0.02 | 31.5 | 0.68 | 4.84 |

| | | | | | | | | |
|---|---|---|---|---|---|---|---|---|
| Final glass composition (% weight) | 65.6 | 2.10 | 16.5 | 0.6 | 8.1 | 2.40 | 4.5 | 0.10 |

As in example 1, the mixture of raw materials is introduced hot into a platinum crucible in a flame furnace (air-gas or oxy-gas combustion) at 1450° C. until the mixture is completely melted for a total duration of 3 h15 including 120 min of refining. The amount of CO₂ released is this time 164 grams, i.e. a decrease of 14% relative to the reference example.

### Example 3

In this example, the mixture of raw materials is this time as described in Table 4 below.

Into this initial mixture, to replace the dolomite, another natural mineral material was introduced as reagent, namely a magnesium silicate from a quarry located in Carino, Spain. The oxide composition of this mineral material is given below.

TABLE 4

| | | Bath | | | | K₂O | | | | | | |
|---|---|---|---|---|---|---|---|---|---|---|---|---|
| Name | Formula | grams | SiO₂ | Al₂O₃ | Na₂O | Weight % | CaO | MgO | B₂O₃ | Fe₂O₃ | CO₂ | H₂O |
| Sand | SiO₂ | 547.50 | 99.60 | 0.05 | | 0.01 | 0.03 | | | 0.03 | | |
| Feldspar | (K,Na)AlSi₃O₈ | 120.80 | 70.60 | 17.05 | 5.65 | 5.20 | 0.10 | 0.01 | | 0.20 | | |
| Na-carbonate | Na₂CO₃ | 237.10 | | | 58.10 | | | | | | 41.89 | |
| Borax | Na₂B₄O₇•5H₂O | 92.60 | | | 21.50 | | | | 48.55 | | | 28.85 |
| Limestone | CaCO₃ | 143.60 | 0.05 | 0.02 | | | 55.55 | 0.25 | | 0.06 | 44.11 | |

| | | | | | | | | | |
|---|---|---|---|---|---|---|---|---|---|
| “Carino” | 64.8 | 39.1 | 2.4 | 0.04 | 0.05 | 1.50 | 36.5 | 8.23 | 12.15 |

| | | | | | | | | |
|---|---|---|---|---|---|---|---|---|
| Final glass composition (% weight) | 65.6 | 2.3 | 16.5 | 0.64 | 8.1 | 2.4 | 4.5 | 0.6 |

As in example 1, the mixture of raw materials is introduced hot into a platinum crucible in a flame furnace (air-gas or oxy-gas combustion) at 1450° C. until the mixture is completely melted for a total duration of 3 h15 including 120 min of refining. The amount of CO₂ released is this time 163 grams, i.e. a decrease of 14% relative to the reference example.

### Example 4

In this example, the mixture of raw materials is this time as described in Table 5 below.

More specifically, in this example, the mineral material “Carino” described in the previous example, as well as another natural mineral material, namely a calcium silicate directly from a quarry located in Hermosillo, Mexico, are used.

TABLE 5

| | | Bath | SiO₂ | Al₂O₃ | Na₂O | K₂O | CaO | MgO | B₂O₃ | Fe₂O₃ | CO₂ | H₂O |
|---|---|---|---|---|---|---|---|---|---|---|---|---|
| Name | Formula | grams | Weight % | | | | | | | | | |
| Sand | SiO₂ | 487.2 | 99.6 | 0.05 | | 0.01 | 0.03 | | | 0.03 | | |
| Feldspar | (K,Na)AlSi₃O₈ | 108.6 | 70.6 | 17.05 | 5.65 | 5.20 | 0.10 | 0.01 | | 0.20 | | |
| Na-carbonate | Na₂CO₃ | 239.2 | | | 58.1 | | | | | | 41.89 | |
| Borax | Na₂B₄O₇•5H₂O | 92.6 | | | 21.5 | | | | 48.55 | | | 28.85 |

| | | | | | | | | | | |
|---|---|---|---|---|---|---|---|---|---|---|
| “Hermosillo” | 171.6 | 40.50 | 0.43 | 0.06 | 0.08 | 46.50 | 0.60 | 0.24 | 11.54 | 0.12 |
| “Carino” | 62.8 | 39.14 | 2.44 | 0.04 | 0.05 | 1.50 | 36.5 | 8.23 | | 12.15 |

| | | | | | | | | |
|---|---|---|---|---|---|---|---|---|
| Final glass composition | 65.6 | 2.10 | 16.5 | 0.6 | 8.10 | 2.40 | 4.50 | 0.60 |

As in example 1, the mixture of raw materials is introduced hot into a platinum crucible in a flame furnace (air-gas or oxy-gas combustion) at 1450° C. until the mixture is completely melted for a total duration of 3 h15 including 120 min of refining. The amount of CO₂ released is this time 120 grams, i.e. a decrease of 37% relative to the reference example.

### Example 5

In this example, the mixture of raw materials is this time as described in Table 6 below.

More specifically, in this example, the same natural silicates of magnesium and calcium as in the preceding example were used, but sodium hydroxide is used this time as a raw material source of Na.

TABLE 6

| | | Bath | SiO₂ | Al₂O₃ | Na₂O | K₂O | CaO | MgO | B₂O₃ | Fe₂O₃ | CO₂ | H₂O |
|---|---|---|---|---|---|---|---|---|---|---|---|---|
| Name | Formula | grams | Weight % | | | | | | | | | |
| Sand | SiO₂ | 487.1 | 99.60 | 0.05 | | 0.01 | 0.03 | | | 0.03 | | |
| Feldspar | (K,Na)AlSi₃O₈ | 108.7 | 70.60 | 17.05 | 5.65 | 5.20 | 0.10 | 0.01 | | 0.20 | | |
| Na-hydroxide | NaOH | 179.3 | | | 77.49 | | | | | | | 22.51 |
| Borax | Na₂B₄O₇•5H₂O | 92.6 | | | 21.50 | | | | 48.55 | | | 28.85 |

| | | | | | | | | | | |
|---|---|---|---|---|---|---|---|---|---|---|
| “Hermosillo” | 171.6 | 40.50 | 0.43 | 0.06 | 0.08 | 46.50 | 0.60 | 0.24 | 11.5 | 0.12 |
| “Carino” | 62.9 | 39.1 | 2.4 | 0.04 | 0.05 | 1.50 | 36.5 | 8.2 | | 12.1 |

| | | | | | | | | |
|---|---|---|---|---|---|---|---|---|
| Final glass composition (wt. %) | 65.6 | 2.10 | 16.5 | 0.6 | 8.10 | 2.40 | 4.50 | 0.60 |

As in example 1, the mixture of raw materials is introduced hot into a platinum crucible in a flame furnace (air-gas or oxy-gas combustion) at 1450° C. until the mixture is completely melted for a total duration of 3 h15 including 120 min of refining. The amount of CO₂ released is this time 20 grams, i.e. a decrease of 90% relative to the reference example.

According to a second series of examples, different mixtures of raw materials are prepared in order to obtain a glass with a composition substantially identical to the formulation described in Table 1, but using recycled glass cullet as raw material.

### Example 6 (Comparative)

According to one reference example, a typical glass composition is synthesized for the production of glass wool or C-glass corresponding to the composition described in Table 7, according to the current techniques and the raw materials commonly used but by introducing 36% of bottle glass cullet therein, the composition of which is given below.

Table 7 below gives the proportions of the various raw materials and the final composition of the mixture thus obtained:

TABLE 7

| | | Bath | SiO₂ | Al₂O₃ | Na₂O | K₂O | CaO | MgO | B₂O₃ | Fe₂O₃ | CO₂ | H₂O |
|---|---|---|---|---|---|---|---|---|---|---|---|---|
| Name | Formula | grams | Weight % | | | | | | | | | |
| Sand | SiO₂ | 292.20 | 99.60 | 0.05 | | 0.01 | 0.03 | | | 0.03 | | |
| Bottle cullet | | 420.50 | 72.50 | 1.50 | 11.70 | 0.30 | 12.30 | 0.90 | | 0.06 | | |
| Feldspar | (K,Na)AlSi₃O₈ | 85.00 | 70.60 | 17.05 | 5.65 | 5.20 | 0.10 | 0.01 | | 0.20 | | |
| Na-carbonate | Na₂CO₃ | 157.30 | | | 58.10 | | | | | | 41.89 | |
| Borax | Na₂B₄O₇•5H₂O | 92.60 | | | 21.50 | | | | 48.55 | | | 28.85 |
| Dolomite | CaMg(CO₃)₂ | 95.10 | 0.05 | 0.05 | | | 30.60 | 21.30 | | 0.16 | 47.80 | |

| | | | | | | | | |
|---|---|---|---|---|---|---|---|---|
| Final glass composition (wt. %) | 65.6 | 2.10 | 16.5 | 0.6 | 8.1 | 2.4 | 4.5 | 0.1 |

The mixture of raw materials is introduced hot into a platinum crucible in a flame furnace (air-gas or oxy-gas combustion) at 1450° C. until the mixture is completely melted for a total duration of 3 h15 including 120 min of refining. The amount of CO₂ released is 111 grams.

### Example 7

In this example, the mixture of raw materials is this time as described in Table 8 below.

More specifically, cullet was used in this example, and as a source of magnesium, the natural mineral compound “Trimouns” described above was used. These materials are directly introduced, without any chemical processing and after simple grinding aimed at adjusting the particle size thereof, in mixture with the cullet and the other constituents in proportions adjusted accordingly to obtain a molten mixture with a composition very close to that of the reference example.

TABLE 8

| | | Bath | SiO₂ | Al₂O₃ | Na₂O | K₂O | CaO | MgO | B₂O₃ | Fe₂O₃ | CO₂ | H₂O |
|---|---|---|---|---|---|---|---|---|---|---|---|---|
| Name | Formula | grams | Weight % | | | | | | | | | |
| Sand | SiO₂ | 98.40 | 99.60 | 0.05 | | 0.01 | 0.03 | | | 0.03 | | |
| Bottle cullet | | 658.00 | 72.50 | 1.50 | 11.70 | 0.30 | 12.30 | 0.90 | | 0.06 | | |
| Feldspar | (K,Na)AlSi₃O₈ | 64.50 | 70.60 | 17.05 | 5.65 | 5.20 | 0.10 | 0.01 | | 0.20 | | |
| Na-carbonate | Na₂CO₃ | 112.20 | | | 58.10 | | | | | | 41.89 | |
| Borax | Na₂B₄O₇•5H₂O | 92.60 | | | 21.50 | | | | 48.55 | | | 28.85 |

| | | | | | | | |
|---|---|---|---|---|---|---|---|
| “Trimouns” | 57.4 | 61.67 | 0.19 | 0.02 | 31.52 | 0.68 | 4.84 |

| | | | | | | | | |
|---|---|---|---|---|---|---|---|---|
| Final glass composition (wt. %) | 65.60 | 2.10 | 16.57 | 0.53 | 8.10 | 2.40 | 4.50 | 0.09 |

As in example 1, the mixture of raw materials is introduced hot into a platinum crucible in a flame furnace (air-gas or oxy-gas combustion) at 1450° C. until the mixture is completely melted for a total duration of 3 h15 including 120 min of refining. The amount of CO₂ released is this time 48 grams, i.e. a decrease of 75% relative to the reference example 1 and of 57% relative to comparative example 6.

### Example 8

In this example, the mixture of raw materials is this time as described in Table 9 below.

More specifically, cullet was used in this example, and as a source of magnesium, the natural mineral compound “Carino” described above was used. These materials are directly introduced, without any chemical processing and after simple grinding aimed at adjusting the particle size thereof, in mixture with the cullet and the other constituents in proportions adjusted accordingly to obtain a molten mixture with a composition very close to that of the reference example.

TABLE 9

| | | Bath | SiO₂ | Al₂O₃ | Na₂O | K₂O | CaO | MgO | B₂O₃ | Fe₂O₃ | CO₂ | H₂O |
|---|---|---|---|---|---|---|---|---|---|---|---|---|
| Name | Formula | grams | Weight % | | | | | | | | | |
| Sand | SiO₂ | 123.10 | 99.60 | 0.05 | | 0.01 | 0.03 | | | 0.03 | | |
| bottle | cullet | 652.00 | 72.50 | 1.50 | 11.70 | 0.30 | 12.30 | 0.90 | | 0.06 | | |
| Feldspar | (K,Na)AlSi₃O₈ | 58.50 | 70.60 | 17.05 | 5.65 | 5.20 | 0.10 | 0.01 | | 0.20 | | |
| Na-carbonate | Na₂CO₃ | 114.40 | | | 58.10 | | | | | | 41.89 | |
| Borax | Na₂B₄O₇•5H₂O | 92.60 | | | 21.50 | | | | 48.55 | | | 28.85 |

| | | | | | | | | | |
|---|---|---|---|---|---|---|---|---|---|
| “Carino” | 49.5 | 39.1 | 2.4 | 0.04 | 0.05 | 1.50 | 36.52 | 8.23 | 12.15 |

| | | | | | | | | |
|---|---|---|---|---|---|---|---|---|
| Final glass composition (wt. %) | 65.6 | 2.1 | 16.6 | 0.5 | 8.1 | 2.4 | 4.5 | 0.46 |

As in example 1, the mixture of raw materials is introduced hot into a platinum crucible in a flame furnace (air-gas or oxy-gas combustion) at 1450° C. until the mixture is completely melted for a total duration of 3 h15 including 120 min of refining. The amount of CO₂ released is this time 48 grams, i.e. a decrease of 75% relative to the reference example 1 and of 57% relative to comparative example 6.

### Example 9

In this example, the mixture of raw materials is this time as described in Table 10 below.

More specifically, cullet was used in this example, and as a source of magnesium, the natural mineral compound “Carino” described above was used, along with NaOH as a source of sodium. These materials are directly introduced, without any chemical processing and after simple grinding aimed at adjusting the particle size thereof, in mixture with the cullet and the other constituents in proportions adjusted accordingly to obtain a molten mixture with a composition very close to that of the reference example.

TABLE 10

| | | Bath | SiO₂ | Al₂O₃ | Na₂O | K₂O | CaO | MgO | B₂O₃ | Fe₂O₃ | CO₂ | H₂O |
|---|---|---|---|---|---|---|---|---|---|---|---|---|
| Name | Formula | grams | Weight % | | | | | | | | | |
| Sand | SiO₂ | 123.10 | 99.60 | 0.05 | | 0.01 | 0.03 | | | 0.03 | | |
| bottle | cullet | 652.00 | 72.50 | 1.50 | 11.70 | 0.30 | 12.30 | 0.90 | | 0.06 | | |
| Feldspar | (K,Na)AlSi₃O₈ | 58.50 | 70.60 | 17.05 | 5.65 | 5.20 | 0.10 | 0.01 | | 0.20 | | |
| Na-hydroxide | Na₂CO₃ | 85.80 | | | 77.49 | | | | | | | 22.51 |
| Borax | Na₂B₄O₇•5H₂O | 92.60 | | | 21.50 | | | | 48.55 | | | 28.85 |

| | | | | | | | | | |
|---|---|---|---|---|---|---|---|---|---|
| “Carino” | 49.5 | 39.14 | 2.4 | 0.04 | 0.05 | 1.50 | 36.5 | 8.2 | 12.15 |

| | | | | | | | | |
|---|---|---|---|---|---|---|---|---|
| Final glass composition | 65.60 | 2.10 | 16.6 | 0.50 | 8.10 | 2.40 | 4.50 | 0.46 |

As in example 1, the mixture of raw materials is introduced hot into a platinum crucible in a flame furnace (air-gas or oxy-gas combustion) at 1450° C. until the mixture is completely melted for a total duration of 3 h15 including 120 min of refining. This melting does not release CO₂.

The advantages and quality of the glass obtained from the molten baths of glass according to the above examples 1 to 9 are indicated in Table 11 below, wherein various assessment criteria obtained according to the following measurements were reported:

1) Yield

This is the ratio between the amount of glass produced and the amount of raw materials charged. The higher this ratio, the higher the amount of glass that can be produced, and the lower the gas emissions (CO₂, H₂O) are.

2) Amount of sand: which is the amount of sand used relative to the reference example 1 (as a percentage of weight saved). In addition to health considerations related to excessive intake of sand (silicosis), decreasing the amount of sand used in favor of other mineral materials such as natural silicates makes it possible to reduce the energy needed to melt the glass, as the most refractory raw material of the melt is generally silica.

3) Energy consumed: this is the amount of energy saved relative to the reference example 1 (as a percentage). This measurement corresponds to the energy necessary for the melting of the mixture of raw materials corresponding to each example.

4) Refining quality (or bubble rate):

The number of bubbles per kilogram of molten glass is measured at 1480° C. for 120 minutes. The higher this index is, the better-quality the refining is.

***: number of example bubbles/number of example 1 reference bubbles <100%

****: number of example bubbles/number of example 1 reference bubbles <50%

5) SiO₂ homogeneity:

The quality index is proportional to the SiO₂ homogeneity (as measured by microprobe/EDS) of the molten glass at 1480° C. for 120 min.

Homogeneity is measured by a series of measurements of the amount of SiO₂ in different points of the glass and a standard deviation is then determined.

**: SiO₂ standard deviation (measured by microprobe/EDS)>0.5%

*** SiO₂ standard deviation (measured by microprobe/EDS between 0.1 and 0.5%

****: SiO₂ standard deviation (measured by microprobe/EDS)<0.1%

TABLE 11

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Yield (%) | 82 | 84 | 83 | 86 | 91 | 87.5 | 92.3 | 91.7 | 94.2 |
| Amount of sand saved (%) | Ref. | 8 | 4 | 15 | 15 | Ref. | 45 | 58 | 58 |
| Energy saved (%) | Ref. | 2.1 | 2.3 | 7.7 | 18.7 | Ref. | 10.9 | 10.9 | 17 |
| Refining | Ref. | *** | | *** | *** | Ref. | *** | | *** |
| SiO₂ homogeneity | ** | *** | *** | *** | *** | ** | *** | *** | *** |

The comparison of the results above shows that examples 2 to 5 and 7 to 9 according to the invention show quality indices generally greater than reference examples 1 to 6.

Examples 4 and 5 according to the invention wherein the raw materials of said molten bath used in combination are a calcium source consisting of a natural mineral calcium silicate and a magnesium source consisting of a natural mineral magnesium silicate appear particularly advantageous, according to all the criteria reported in the above table 9.

1. A method for manufacturing glass having a target composition, comprising melting a mixture of raw materials constituting a melting bath, said target composition meeting the following criteria, in weight percentages:
SiO₂: between 50 and 75%,
Na₂O: between 10 and 25%,
CaO: between 5 and 15%,
MgO: between 1 and 10%,
B₂O₃: between 0 and 10%,
Al₂O₃: between 0 and 8%,
K₂O: between 0 and 5%,
Iron oxide: between 0 and 3%,
other oxide(s): between 0 and 5% in total by weight,
the remainder consisting of unavoidable impurities,
said method comprising:
a) selecting the raw materials of said melt from, at least:
a silicon source,
at least one sodium source,
at least one boron source,
at least one calcium source selected from a natural mineral calcium silicate comprising, in percentage by weight, more than 30% of SiO₂ and more than 10% CaO, CaO and SiO₂ together representing more than 60% of the total weight of said source, and/or
at least one magnesium source selected from a natural mineral magnesium silicate comprising, in percentage by weight, more than 30% of SiO₂ and more than 10% MgO, MgO and SiO₂ together representing more than 60% of the weight of said source,
optionally at least one aluminum source selected from a mixed aluminum oxide with at least one element selected from the group consisting of Si, Ca, Na, K,
wherein said calcium and/or magnesium and/or aluminum sources are natural mineral materials, that is, unprocessed mineral materials originating from a natural geological environment,
optionally, limestone CaCO₃ or a calcium hydroxide such as Portlandite Ca(OH)₂,
optionally dolomite CaMg(CO₃)₂,
optionally, hydrated alumina (Al(OH)₃) or calcinated alumina Al₂O₃,
b) determining the composition of said sources of calcium and/or magnesium and/or natural aluminum,
c) on the basis of said composition(s) determined according to point b), determining necessary quantities of said raw materials to obtain a glass of said target composition,
d) mixing said materials according to said quantities,
e) melting said mixture and cooling said mixtures under conditions making it possible to obtain said glass.

2. The method according to claim 1, wherein said calcium source is a natural mineral calcium silicate comprising, in percentage by weight, more than 30% of SiO₂ and more than 15% CaO, CaO and SiO₂ together representing more than 60% of the total weight of said source.

3. The method according to claim 2, wherein said magnesium source is a natural mineral magnesium silicate comprising, in percentage by weight, more than 30% of SiO₂ and more than 15% MgO, MgO and SiO₂ together representing more than 60% of the weight of said source.

4. The method according to claim 2, wherein the raw materials of said molten bath comprise a calcium source which is a natural mineral calcium silicate comprising, in percentage by weight, more than 30% SiO₂ and more than 15% CaO, CaO and SiO₂ together representing more than 70% of the total weight of said source and a magnesium source which is a natural mineral magnesium silicate comprising, in percentage by weight, more than 30% SiO₂ and more than 10% MgO, MgO and SiO₂ together representing more than 70% of the total weight of said source.

5. The method according to claim 1, wherein said magnesium source is a natural mineral material corresponding to the following composition, in percentages by weight:
SiO₂: between 40 and 55%,
Al₂O₃: between 0 and 10%,
MgO: between 20 and 40%,
MgO and SiO₂ cumulatively representing at least 70%,
Fe₂O₃: between 0 and 4%,
less than 5% of other oxides,
optionally water.

6. The method according to claim 1, wherein said magnesium source is a natural mineral material corresponding to the following composition, in percentages by weight:
SiO₂: between 55 and 70%,
Al₂O₃: between 0 and 10%,
MgO: between 20 and 40%,
MgO and SiO₂ cumulatively representing at least 85%,
Fe₂O₃: between 0 and 4%,
less than 5% of other oxides,
optionally water.

7. The method according to claim 1, wherein said magnesium source is a natural mineral material corresponding to the following composition, in percentages by weight:
SiO₂: between 30 and 50%,
Al₂O₃: between 0 and 10%,
MgO: between 25 and 45%,
MgO and SiO₂ cumulatively representing at least 70%,
Fe₂O₃: between 0 and 10%,
less than 5% of other oxides,
optionally water.

8. The method according to claim 1, wherein said calcium source is a natural mineral material corresponding to the following composition, in percentages by weight:
SiO₂: between 30 and 55%,
CaO: between 35 and 55%,
CaO and SiO₂ cumulatively representing at least 80%,
Fe₂O₃: between 0 and 4%,
Al₂O₃: between 0 and 5%,
CO₂: between 0 and 20%,
less than 5% of other oxides.

9. The method according to the claim 1, wherein said calcium source is a natural mineral material corresponding to the following composition, in percentages by weight:
SiO₂: between 40 and 55%,
CaO: between 10 and 30%,
CaO and SiO₂ cumulatively representing at least 55%,
Al₂O₃: between 10 and 40%,
Fe₂O₃: between 0 and 4%,
Na₂O: between 0 and 4%,
less than 5% of other oxides.

10. A method comprising providing at least one magnesium source as described in claim 5 and at least one calcium source as raw materials.

11. The method according to claim 1, comprising introducing recycled glass cullet and/or recycled mineral fibers into the molten bath.

12. The method according to claim 11, wherein the recycled glass cullet and/or recycled mineral fibers represent between 1 and 50% of the total weight of the molten bath.

13. The method according to claim 1, wherein the glass cullet satisfies the following composition, in percentage by weight:
SiO₂: between 65 and 80%,
Na₂O: between 5 and 20%,
CaO: between 5 and 20%,
Al₂O₃: between 0 and 10%,
MgO: between 0 and 5%,
Fe₂O₃: between 0 and 2%,
less than 5% of other oxides.

14. (canceled)

15. A mixture of raw materials comprising:
a silicon source,
at least one sodium source,
at least one boron source,
at least one calcium source selected from a natural mineral calcium silicate comprising, in percentage by weight, more than 30% of SiO₂ and more than 10% CaO, CaO and SiO₂ together representing more than 60%, or more than 70% of the total weight of said source, and/or
at least one magnesium source selected from a natural mineral magnesium silicate comprising, in percentage by weight, more than 30% of SiO₂ and more than 10% MgO, MgO and SiO₂ together representing more than 60% of the weight of said source,
optionally at least one aluminum source selected from a mixed aluminum oxide with at least one element selected from the group consisting of Si, Ca, Na, K,
wherein said calcium and/or magnesium and/or aluminum sources are natural mineral materials, that is, unprocessed mineral materials originating from a natural geological environment,
optionally, limestone CaCO₃ or a calcium hydroxide,
optionally dolomite CaMg(CO₃)₂,
optionally, hydrated alumina (Al(OH)₃) or calcinated alumina Al₂O₃.

16. The method according to claim 1, wherein said target composition meeting the following criteria, comprises, in weight percentages:
SiO₂: between 60 and 70%,
Na₂O: between 10 and 20%,
CaO: between 5 and 10%,
MgO: between 2 and 5%,
CaO and MgO together representing between 5 and 20%
B₂O₃: between 2 and 8%,
Al₂O₃: between 1 and 6%,
K₂O: between 0.5 and 2%,
Na₂O and K₂O together representing between 12 and 20%,
Iron oxide: less than 2%,
other oxide(s): less than 3% in total.

17. The method according to claim 1, wherein
the silicon source includes one or more of silica, a glass cullet and recycled mineral fibers,
the at least one sodium source includes sodium hydroxide NaOH, sodium carbonate Na₂CO₃ or a mixture of sodium hydroxide NaOH and sodium carbonate Na₂CO₃
the at least one boron source is selected from a boron oxide or a mixed oxide of boron with at least one element selected from the group consisting of Si, Mg and Ca,
the at least one calcium source is a calcium silicate and/or an aluminum and calcium silicate,
the at least one magnesium source is a magnesium silicate,
the optional at least one aluminum source is an aluminum silicate.

18. The method according to claim 1, wherein said obtained glass is in the form of fibers after fiber drawing.

19. The method according to claim 2, wherein CaO and SiO₂ together representing more than 70% of the total weight of said source.

20. The method according to claim 3, wherein MgO and SiO₂ together representing more than 70% of the weight of said source.

21. The method according to claim 4, wherein CaO and SiO₂ together represent more than 80% of the total weight of said at least one calcium source and MgO and SiO₂ together represent more than 80% of the total weight of said at least one magnesium source.
